(19) United States
(12) Patent Application Publication
(10) Pub. No.: US 2010/0242034 A1
(43) Pub. Date: Sep. 23, 2010

(54) DISTRIBUTING SOFTWARE PRODUCTS AS AN EXECUTABLE CONTAINING SCRIPT LOGIC WITH EXTERNAL RESOURCES

(75) Inventors: Steven G. Rugh, Issaquah, WA (US); Thomas J. Donchess, Poulsbo, WA (US); Michel S. Abraham, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/794,860

(22) Filed: Jun. 7, 2010

Related U.S. Application Data
(63) Continuation-in-part of application No. 11/590,979, filed on Nov. 1, 2006.

(51) Int. Cl. G06F 9/445; G06F 9/44

(52) U.S. Cl. 717/172; 717/177

(57) ABSTRACT

An installation script may be utilized to install a software product containing a program file, using a single executable file. An installation script for managing installation operations may be generated by a computing device. The installation script may be combined with the program file associated with the installation operations. A single executable file that includes the combined installation script and the program file may be generated by the computing device. The single executable file may be distributed by the computing device. The single executable file may be executed by the computing device. Executing the single executable file may include querying a manifest, within the single executable file, which includes a list of resource files external to the single executable file. The resource files may be utilized by the single executable file to install the program file.

### CROSS-REFERENCE TO RELATED APPLICATIONS

The present application is a continuation-in-part of U.S. patent application Ser. No. 11/590,979, entitled “Packaging Software Products As Single-File Executables Containing Script Logic,” filed on Nov. 1, 2006 and expressly incorporated herein by reference.

### BACKGROUND

Software products and updates may require multiple distribution media (e.g., digital versatile disks or “DVDs”) for executable program files. In many instances, executable program files require a number of resource files, such as Cabinet (“CAB”) files for various activities such as the installation of software product updates. Currently however, due to size constraints associated with CAB files as well as computer-based file systems (e.g., FAT32 file systems), executable program files may be limited to only a single CAB file even when the distributed media itself (e.g., the DVD) may be capable of storing additional data. As a result of the aforementioned limitation, additional executable program files must be utilized in order to access any additional required CAB files for installing software products or associated updates. The drawbacks of utilizing multiple executable program files include longer production times for distribution media (i.e., each executable file must be generated separately), forced partitioning of the multiple executable program files onto a single distribution media and/or additional copies of distribution media, and increasing the time required for signing data using digital signatures. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to installing a software product, comprising a program file, using a single executable file. An installation script for managing installation operations may be generated by a computing device. The installation script may be combined with the program file associated with the installation operations. A single executable file that includes the combined installation script and the program file may be generated by the computing device. The single executable file may be distributed by the computing device. The single executable file may be executed by the computing device. Executing the single executable file may include querying a manifest, within the single executable file, which includes a list of resource files external to the single executable file. The resource files may be utilized by the single executable file to install the program file.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates a conceptual diagram of an installation executable distribution according to embodiments;

FIG. 2 illustrates a diagram of an example creation of an installation executable;

FIG. 3 illustrates an example installation process using a scripted installation executable according to embodiments;

FIG. 4 illustrates use distribution of an installation executable in a networked system;

FIG. 5 is a block diagram of an example computing operating environment, where embodiments may be implemented;

FIG. 6 illustrates an example of a resource file manifest and external resource files stored on a portable storage medium according to embodiments; and

FIG. 7 illustrates a logic flow diagram for a process of installing a software product comprising a program file, using a single executable file, according to embodiments.

### DETAILED DESCRIPTION

As briefly described above, embodiments are directed to installing a software product, comprising a program file, using a single executable file. An installation script for managing installation operations may be generated by a computing device. The installation script may be combined with the program file associated with the installation operations. A single executable file that includes the combined installation script and the program file may be generated by the computing device. The single executable file may be distributed by the computing device. The single executable file may be executed by the computing device. Executing the single executable file may include querying a manifest, within the single executable file, which includes a list of resource files external to the single executable file. The resource files may be utilized by the single executable file to install the program file.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information.

Communication media includes any information delivery media. For example, in accordance with an embodiment, communication media may include a wired network or direct-wired connection. In accordance with another embodiment, communication media may include wireless media such as acoustic, RF, infrared, and other wireless media. In accordance with yet another embodiment, communication media may include computer-readable instructions, data structures, program modules or other data in a modulated data signal such as a carrier wave or other transport mechanism. The term “modulated data signal” means a signal that has one or more of its characteristics set or changed in such a manner as to encode information in the signal. Combinations of any of the above should also be included within the scope of computer-readable media. Computer-readable media may also be referred to as a computer program product.

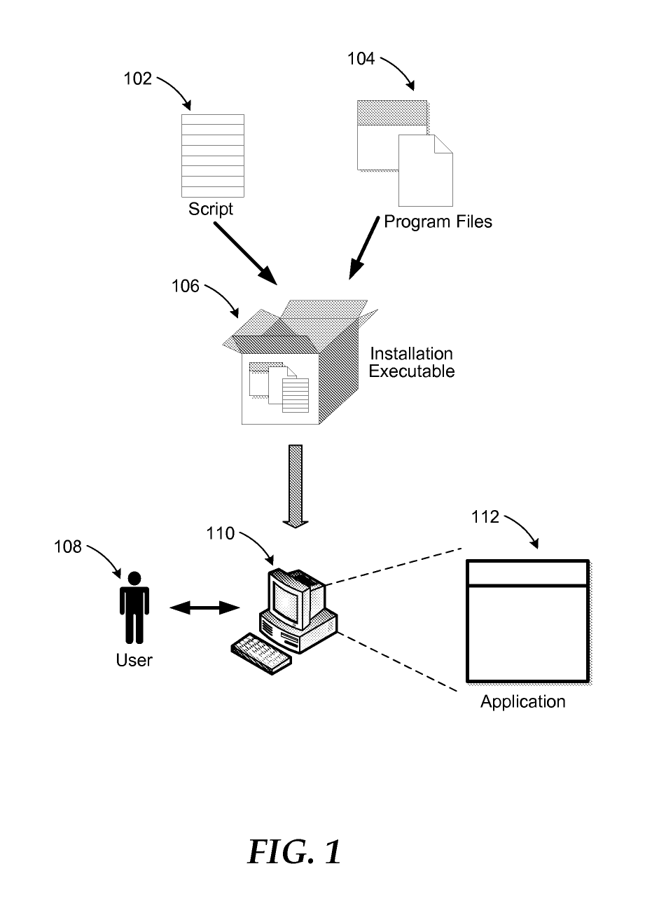

Referring to FIG. 1, a conceptual diagram of an installation executable distribution according to embodiments is illustrated. In accordance with an embodiment, software products or updates may be distributed via various media including portable media, such as, DVDs. Furthermore, a scripted installation executable may allow customizable and extensible sequencing of installation operations. A packaging tool according to embodiments creates a single self-extracting executable file from individual installation files and an installation script that flexibly accomplishes the pre-requisite checks, installs the software product, and performs any post-installation operations.

Typically, installation files for a software product or an update include a number of data files, DLLs, and other types of files. In some cases, these may be organized in a plurality of directories. In addition to potential downloading problems, dealing with multiple files increases risks of unauthorized use (e.g. individual files may be easier to tamper with) and limits customizability of installation processes.

As shown in FIG. 1, program files 104 may include a number of different types of files. Script file 102 may be generated in a structured language such as Extensible Markup Language (XML) such that actions associated with the installation are sequenced and/or chained according to a predefined policy. The script according to a schema may allow use of alternative dialogs, languages, and other installation options. Script file 102 and program files 104 may be combined into installation executable 106 for a compact, downloadable method of distribution. Installation executable 106 may be distributed in various ways to the users (e.g. user 108) such as using portable media.

Once loaded onto a computing device such as desktop computer 110, the installation executable may be executed, where the script controls the execution of individual actions interacting with user 108, performing pre-installation checks, copying and/or expanding program files, configuring and/or registering components, and the like. Post-installation tasks such as activating installed application 112, deleting unnecessary files, and the like.

As mentioned above, the schema defining the installation script may be in XML format. However, embodiments are not limited to the XML programming languages and formats. Packaging software products in a single executable file containing scripting logic may be implemented in any language, format, and structure using the principles described herein.

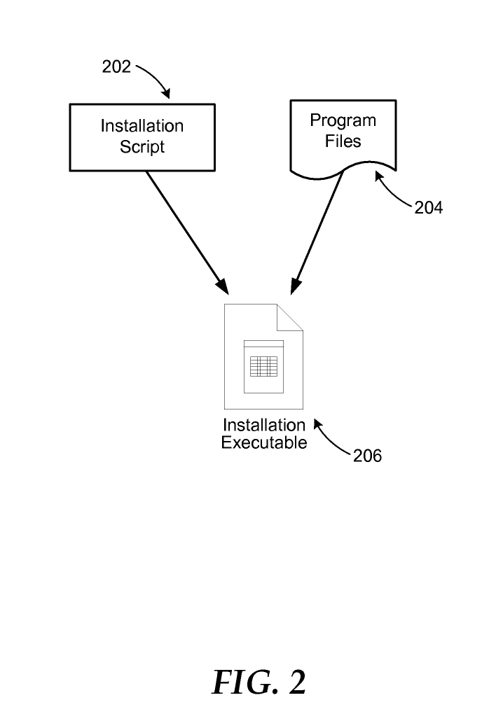

FIG. 2 illustrates a diagram of an example creation of an installation executable. At the core of a single-file installation system according to embodiments is the installation script 202. The script defines a behavior for the installation package as a list of actions to be performed in a specific order. The actions, in turn, control interactions with the user through dialogs, perform pre-installation checks, query and configure system components, and install program files.

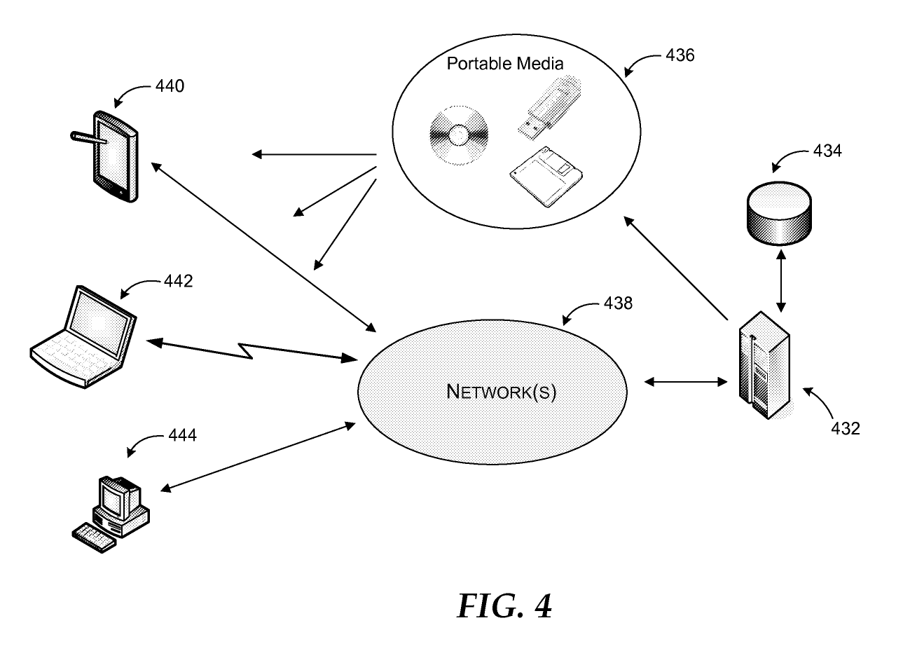

In generating the installation executable 206, the program files 204 and installation script 202 are combined into a single file. The installation executable may be compressed or otherwise processed for distribution in any way known in the art. Security measures, such as password protection, may also be integrated into the installation executable 206. The installation executable 206 is then distributed to the users through various methods such as those described in conjunction with FIG. 4.

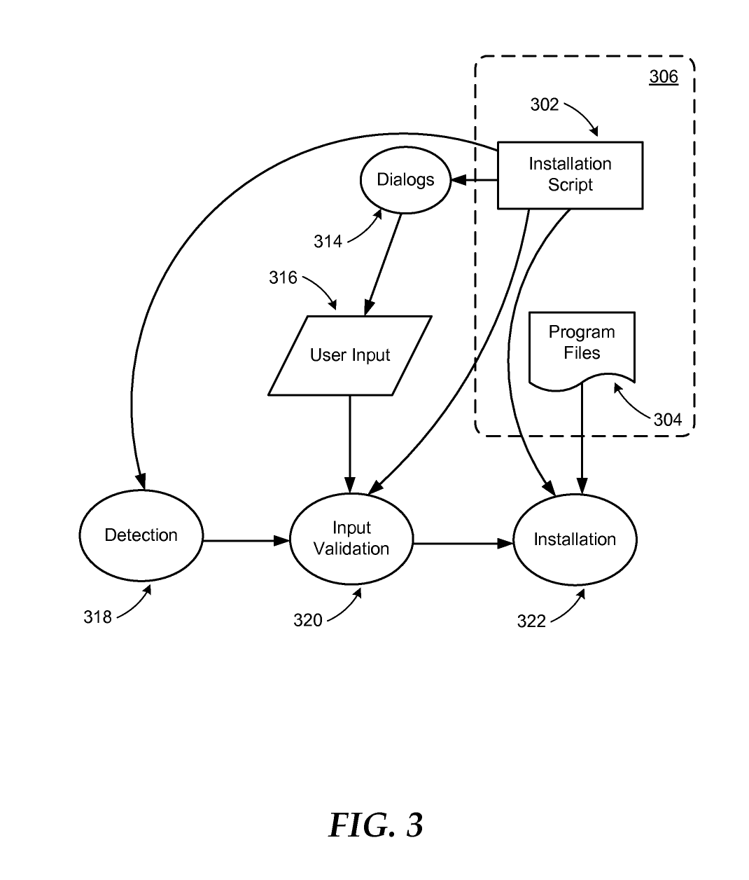

FIG. 3 illustrates an example installation process using a scripted installation executable according to embodiments. The executable (306) controls installation operations through a series of actions defined in installation script 302.

Installation executable 306, according to embodiments, conforms to an extensibility model where it is able to load Dynamic Link Libraries (DLLs) and is able to call into functions with a specific signature, thus allowing the addition of new features that cannot just be “coded” using the XML language. This way, the UI experience may be changed without affecting a package behavior.

The behavior for the package may be defined in an XML file as a list of actions to be performed in a specific order. This order may be defined by the order of the elements in the XML file. Each of these actions may be defined as an <Action> element with a type attribute that defines what kind of action is called. An example piece of code is provided below:

```
<Action type=“YesNoPrompt”>
    <Title>$(TEST.TITLE)</Title>
    <Text>This script will test the file actions, do you want to
    continue</Text>
    <Button type=“No”>
        <Action type=“Quit” />
    </Button>
</Action>
```

The action described above is an action of type YesNoPrompt, which when executed by the interpreter prompts the user with a YES/NO message box. The example code also shows that each action element may contain all of the information required to execute it. In this case, the action contains the text for the title, the $(TEST.TITLE) is a reference to a property, the text for the prompt and what to do if the user presses the button NO.

Installation executable 306 performs multiple tasks once it is executed. These tasks may include detection, user interaction, installation, and post-installation tasks. Detection may include determination of environmental parameters such as system capabilities (processor speed, available memory and hard disk space, and the like), existing product(s) and/or product qualification, version(s) of existing components, language, user preferences (e.g. currency, date and time, and the like).

In an update scenario, the executable may detect if a patch or update is needed by or applicable to the system before doing so. The script may be set up such that the executable may be run in a “detection” mode to determine whether the patch is needed or not, but not install the patch. This mode provides users a simple way of knowing if the patch is needed, installed or not applicable. Once the script determines the applicability of the update, pre-requisite installation criteria may be checked prior to installing the payload. This check may include, but is not limited to, qualifying product(s), preferred language, operating system and/or platform, and required baseline updates. In some cases, an order of updates may be critical for the program. The script may determine which updates are already installed and install any additional ones according to the prescribed order. If there are time limitations on a patch such as an expiration date, the script may determine that and propose to the user to download and install a different patch. The users may also be directed to a download center, where they can download the package themselves.

The use of a schema-based script for describing the actions enables custom dialogs, actions, and custom execution of the actions. Thus, a developer may easily modify the installation executable by changing the installation script 302 and customizing the installation package for a particular purpose. Installation script 302 also provides the ability to create a universal package applicable to any language. Each package may contain language resources for as many languages as necessary.

In the case of update packaging, part of the payload of the update package may be update metadata for consumption by end users and other systems. For example, the XML schema-based script and delivery method may be employed to keep an inventory of the patches in a database.

According to some embodiments, additional installation and post-installation tasks controlled by the installation script 302 may include transmission of failure reports to a monitoring center, activation of components, querying of system resources to gather information regarding existing components and registry operations. A time-sensitive limitation may even be included such that the script may check a download center for current updates if a pre-defined deadline for installing the product has expired. According to other embodiments, installation script 302 may also include rules that define constraints on installation parameters such as which components are to be installed for a given language or user ID.

In an operation, installation script 302 initiates the installation process with the detection actions 318 as described above. Once sufficient information is gathered the script interacts with the user by prompting dialogs 314 and receiving user input 316. The information provided by the user, such as a product key number, user name, and the like, may then be validated in a input validation operation 320. The installation operations 322, such as copying of program files 304, configuration and registration of components, and the like, follow the input validation 320. In some embodiments, post-installation operations such as those described above may also be performed upon successful completion of installation operations 322.

Embodiments are not limited to the illustrated examples operations and components in FIG. 1 through FIG. 2. Other architectures may be implemented using the principles described herein for a software installation packaging system using single-file executables containing scripting logic.

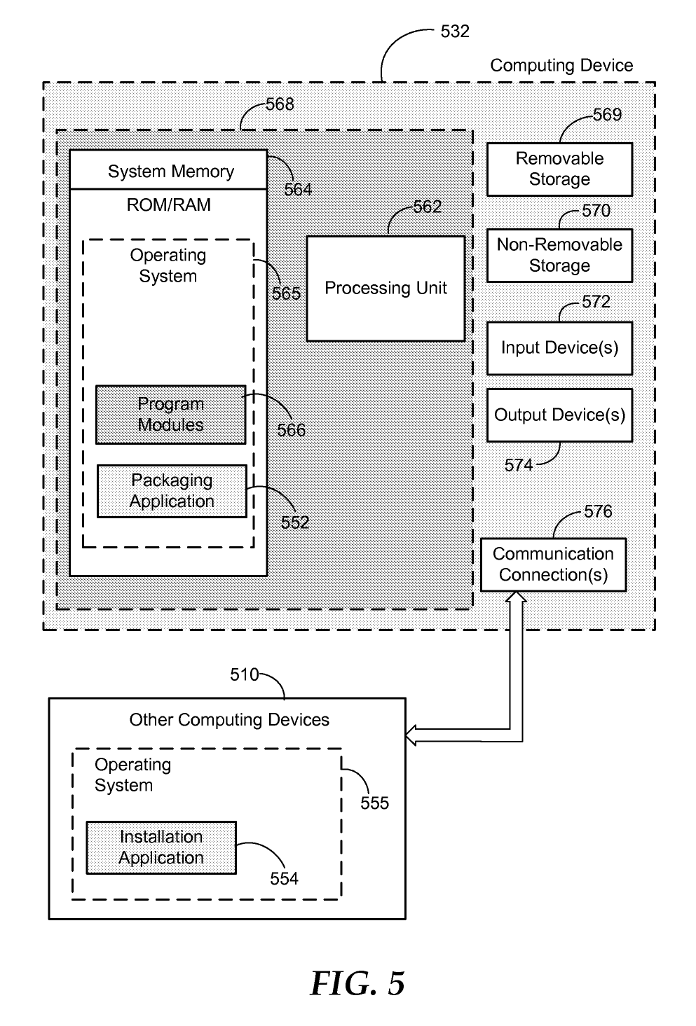

Referring now to the following figures, aspects and exemplary operating environments will be described. FIG. 4, FIG. 5, and the associated discussion are intended to provide a brief, general description of a suitable computing environment in which embodiments may be implemented.

FIG. 4 illustrates use distribution of an installation executable in a networked system. The system may comprise any topology of servers, clients, Internet service providers, and communication media. Also, the system may have a static or dynamic topology. The term “client” may refer to a client application or a client device employed by a user to perform operations associated with installing a software product. While a networked product installation file distribution system may include many more components, relevant ones are discussed in conjunction with this figure.

In a typical operation according to embodiments, server 432 executes one or more applications that prepare an installation script for a software product, retrieve program files associated with installing the software product from data store 434, and combine the script and the program files into a single-file installation executable. The single-file executable may then be distributed to users through one or more networks 438 or using portable storage media. Portable storage media may include any method of storing and distributing files such as CD-ROMs, DVDs, floppy disks, flash drives, and others.

Server 438 may include additional programs with various functionalities associated with the installation of the software product such as an error monitoring program, a current update download program, and the like. These functionalities and similar ones may also be provided by other servers. As mentioned previously, distribution of software products by downloading over networks is becoming increasingly common. Commonly, there are two primary online software distribution scenarios. The first scenario is distribution of complete software programs, which is occurring with increasing frequency over networks. The second and more common scenario is distribution of product updates (e.g. security updates, functional patches, and the like) over the networks.

Network(s) 438 may include a secure network such as an enterprise network, an unsecured network such as a wireless open network, or the Internet. Network(s) 438 provide communication between the nodes described herein. By way of example, and not limitation, network(s) 438 may include wired media such as a wired network or direct-wired connection, and wireless media such as acoustic, RF, infrared and other wireless media.

Once distributed, the installation executable may be activated in any computing device including, but not limited to, the example devices of Personal Digital Assistant (PDA) 440, laptop computer 442, and desktop computer 444.

Many other configurations of computing devices, applications, data sources, data distribution and analysis systems may be employed to implement distribution of a software product using single-file executables containing scripting logic. Furthermore, the networked environments discussed in FIG. 4 are for illustration purposes only. Embodiments are not limited to the example applications, modules, or processes. A networked environment for using an installation executable with an installation script and program files may be provided in many other ways using the principles described herein.

With reference to FIG. 5, a block diagram of an example computing operating environment is illustrated, such as computing device 532. In a basic configuration, the computing device 532 typically includes at least one processing unit 562 and system memory 564. Computing device 532 may include a plurality of processing units that cooperate in executing programs. Depending on the exact configuration and type of computing device, the system memory 564 may be volatile (such as RAM), non-volatile (such as ROM, flash memory, etc.) or some combination of the two. System memory 564 typically includes an operating system 565 suitable for controlling the operation of a networked personal computer, such as the WINDOWS® operating systems from MICROSOFT CORPORATION of Redmond, Wash. The system memory 564 may also include one or more software applications such as program modules 566 and packaging application 552.

As described previously in more detail, packaging application 552 manages the creation of the installation script for controlling the installation of a software product and/or its updates and combines the installation script with applicable program files for installing the product (or updates). Packaging application 552, and any other related programs may be an integrated part of a distribution application or operate remotely and communicate with the distribution application and with other applications running on computing device 532 or on other devices. Furthermore, packaging application 552 may be executed in an operating system other than operating system 565. This basic configuration is illustrated in FIG. 5 by those components within dashed line 568.

The computing device 532 may have additional features or functionality. For example, the computing device 532 may also include additional data storage devices (removable and/or non-removable) such as, for example, magnetic disks, optical disks, or tape. Such additional storage is illustrated in FIG. 5 by removable storage 569 and non-removable storage 570. Computer storage media may include volatile and nonvolatile, removable and non-removable media implemented in any method or technology for storage of information, such as computer readable instructions, data structures, program modules, or other data. System memory 564, removable storage 569 and non-removable storage 570 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 532. Any such computer storage media may be part of device 532. Computing device 532 may also have input device(s) 572 such as keyboard, mouse, pen, voice input device, touch input device, etc. Output device(s) 574 such as a display, speakers, printer, etc. may also be included. These devices are well known in the art and need not be discussed at length here.

The computing device 532 may also contain communication connections 576 that allow the device to communicate with other computing devices 510, such as over a network in a distributed computing environment, for example, an intranet or the Internet. Communication connection 576 is one example of communication media. Communication media includes any information delivery media. For example, in accordance with an embodiment, communication media may include a wired network or direct-wired connection. In accordance with another embodiment, communication media may include wireless media such as acoustic, RF, infrared, and other wireless media. In accordance with yet another embodiment, communication media may include computer-readable instructions, data structures, program modules or other data in a modulated data signal such as a carrier wave or other transport mechanism. The term “modulated data signal” means a signal that has one or more of its characteristics set or changed in such a manner as to encode information in the signal. Combinations of any of the above should also be included within the scope of computer-readable media. Computer-readable media may also be referred to as a computer program product.

As described in detail previously, the installation executable created by packaging application 552 may be distributed through communication connections 576 to other computing devices 510, where it may be executed as installation application 506 within operating system 555. Operating systems 565 and 555 do not necessarily have to be the same.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

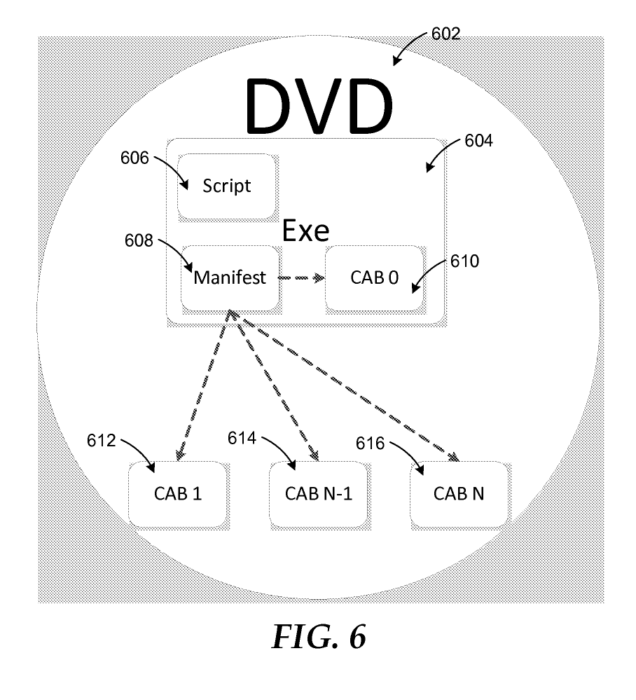

FIG. 6 illustrates an example of a resource file manifest and external resource files stored on a portable storage medium, such as DVD 602, according to embodiments. The DVD 602 may store an installation executable file 604 which includes a script file 606, a manifest 608, and a resource file (i.e., CAB 0 file 610). The DVD 602 may further store external resource files such as CAB 1 file 612, CAB N-1 file 614, and CAB N file 616. The installation executable file 604 may be utilized to install or update a software product through the utilization of the external resource files 612-616. In particular, upon executing the installation executable file 604, the script file 606 may be configured to query the manifest 608 for the external resource files 612-616 for utilization in installation operations with respect to the installation or update of a software product. In accordance with an embodiment, the manifest 608 may comprise a markup language namespace section (such as an XML namespace section) within the installation executable file 604 which includes a list with pointers to an internal resource file (i.e., the CAB 0 file 510) within the installation executable file 604 as well as to one or more external resource files (i.e., the CAB 1 file 612, the CAB N-1 file 614, and the CAB N file 616). It should be appreciated by those skilled in the art, that the manifest 608 removes a constraint previously associated with the installation executable 604 in which only a single enclosed CAB file could previously be utilized during the installation or update of a software product due to size constraints. In particular, the manifest 608 enables the installation executable 604 to access external CAB files that are on the DVD 602 but that are not included within the installation executable file 604 itself. Thus, the size constraints previously imposed by CAB files as well as by computer-based file systems, such as FAT 32 file systems, are removed with the only remaining constraint being the maximum size of the media (e.g., the DVD 602) containing the installation executable file 604 and any other resource files that can be stored. It should further be appreciated that the ability to have additional resource files (i.e., CAB files) for utilization by an installation executable file allows for the division of the software product or upgrade into multiple parts. As a result, a computer system producing the software product or upgrade may handle smaller chunks of data at a time. It should further be appreciated that the ability to have additional resource files (i.e., CAB files) for utilization by an installation executable file allows for more convenient and scalable layouts for computer-readable storage media (such as DVDs).

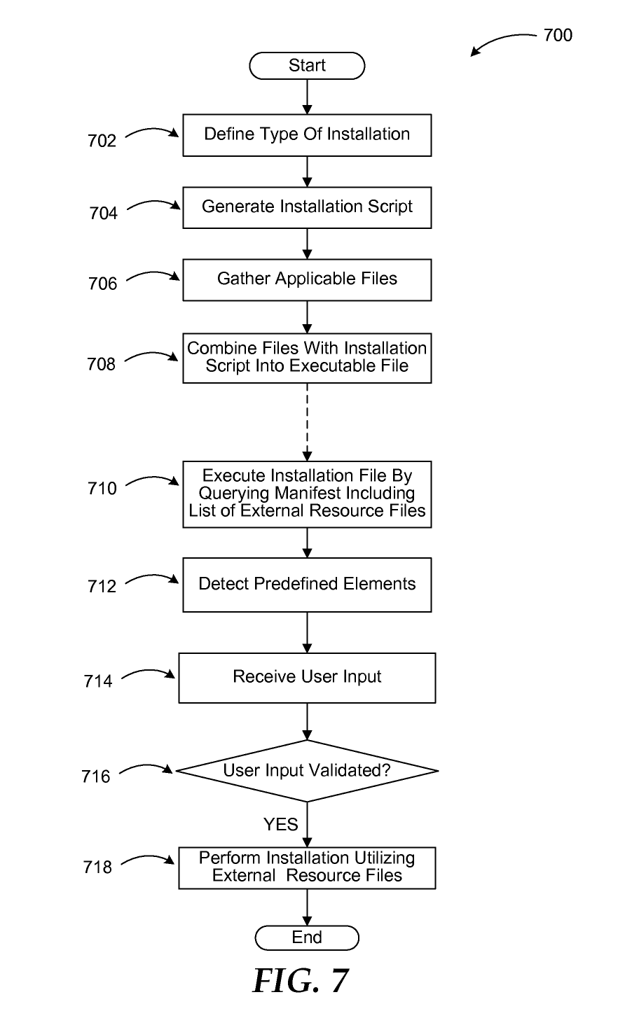

FIG. 7 illustrates a logic flow diagram for a process of creating and using a scripted installation executable. Parts of process 700 may be implemented in a packaging application, an installation executable, and the like.

Process 700 begins with operation 702, where a type of installation is defined. The type of installation, whether a new product installation or an update/patch installation may determine how an installation script is to be generated and an order of installation operations. Processing advances from operation 702 to operation 704.

At operation 704, the installation script is generated defining the actions and the order of actions for the installation tasks. The schema-based script may be generated using a structured language such as XML and is customizable and extensible. Processing proceeds from operation 704 to operation 706.

At operation 706, applicable program files are gathered. For each type of installation different sets of files including data files, DLLs, and the like may be necessary. Processing moves from operation 706 to operation 708.

At operation 708, the gathered program files and the installation script are combined into a single-file installation executable that can be downloaded over a network or distributed on a portable storage medium. Following operation 708, the installation executable is distributed to the users. A second portion of the process begins when a user executes the installation file. This gap in the operations is represented in process 700 with a dashed line.

At operation 710, the installation file is executed on a user computer. The execution activates the installation script, which begins performing the tasks in a predefined order. As discussed above with respect to FIG. 6, the tasks may include querying a manifest within the installation file (i.e., the executable file). The manifest may include a list of resource files (i.e., CAB files) external to the installation file. The manifest may be included in a markup language namespace section within the installation file.

At operation 712, predefined elements such as system capacity (memory, hard disk space, etc.), existing software components, and the like may be detected. Based on the detection results, the installation script may prompt the user to provide input such as selections, product key, user information, and the like. Processing advances from operation 712 to operation 714.

At operation 714, user input in response to the script prompted dialog(s) are received. The dialogs and a UI for the user to provide input may be customized by the script based on a type of installation, a system environment, and the like. Processing advances from operation 714 to decision operation 716.

At decision operation 716, a determination is made whether part or all of the user input is valid. If the user input is valid, processing advances from decision operation 716 to operation 718.

At operation 718, the installation tasks including, but not limited to, copying of files, activation of components, registration of components, and the like, are performed. For example, and as discussed above with respect to FIG. 6, the installation tasks performed by the installation file (i.e., executable file) may, in particular, include, utilizing the external resource files (i.e., CAB files) to install a program file comprising a software product or update. After operation 718, processing may move to a calling process for further actions, and then ends.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for installing a software product, comprising a program file, using a single executable file, comprising:
generating, by the computing device, an installation script for managing installation operations;
if the installation operations are associated with the program file, combining, by the computing device, the installation script with the program file associated with the installation operations;
generating, by the computing device, the single executable file that includes the combined installation script and the program file;
distributing, by the computing device, the single executable file; and
executing, by the computing device, the single executable file, wherein executing the single executable file comprises querying a manifest within the single executable file, the manifest comprising a list of a plurality of resource files external to the single executable file, wherein the plurality of external resource files are utilized by the single executable file to install the program file.

2. The method of claim 1, wherein querying a manifest within the single executable file comprises querying a markup language namespace section within the single executable file.

3. The method of claim 1, wherein generating an installation script of managing installation operations comprises generating an installation script based on a type of installation.

4. The method of claim 1, wherein executing the single executable file further comprises:
detecting a system parameter associated with a user computing device;
prompting a dialog to receive a user input for a script parameter;
receiving the user input; and
performing predefined actions associated with the installation operations based on the detected system parameter and the received user input.

5. The method of claim 4, wherein executing the single executable file further comprises:
determining an error in response to an action not being performed properly;
prompting a dialog to provide the user a feedback; and
reporting the error to a predefined monitoring application.

6. The method of claim 4, wherein executing the single executable file further comprises:
detecting an existing software product component, if the installation is for an update; and
determining whether the existing component is eligible for the update.

7. The method of claim 4, wherein executing the single executable file further comprises performing post-installation actions that include at least one from a set of: registering the software product, deleting temporarily created files, and activating at least one component of the software product.

8. The method of claim 1, wherein distributing the single executable file includes providing the file on a computer readable storage medium.

9. A computer-readable storage medium having computer executable instructions which, when executed by a computer, will cause the computer to perform a method of installing a software product, comprising a program file, using a single executable file, the method comprising:
generating an installation script for managing installation operations;
if the installation operations are associated with the program file, combining the installation script with the program file associated with the installation operations;
generating the single executable file that includes the combined installation script and the program file;
distributing the single executable file; and
executing the single executable file, wherein executing the single executable file comprises querying a manifest within the single executable file, the manifest comprising a list of a plurality of resource files external to the single executable file, wherein the plurality of external resource files are utilized by the single executable file to install the program file.

10. The computer-readable storage medium of claim 9, wherein querying a manifest within the single executable file comprises querying a markup language namespace section within the single executable file.

11. The computer-readable storage medium of claim 9, wherein generating an installation script of managing installation operations comprises generating an installation script based on a type of installation.

12. The computer-readable storage medium of claim 9, wherein executing the single executable file further comprises:
detecting a system parameter associated with a user computing device;
prompting a dialog to receive a user input for a script parameter;
receiving the user input; and
performing predefined actions associated with the installation operations based on the detected system parameter and the received user input.

13. The computer-readable storage medium of claim 12, wherein executing the single executable file further comprises:
determining an error in response to an action not being performed properly;
prompting a dialog to provide the user a feedback; and
reporting the error to a predefined monitoring application.

14. The computer-readable storage medium of claim 12, wherein executing the single executable file further comprises:
detecting an existing software product component, if the installation is for an update; and
determining whether the existing component is eligible for the update.

15. The computer-readable storage medium of claim 12, wherein executing the single executable file further comprises performing post-installation actions that include at least one from a set of: registering the software product, deleting temporarily created files, and activating at least one component of the software product.

16. A system for installing a software product, comprising a program file, using a single executable file, comprising:
a memory storage for storing executable program code;
a processing unit coupled to the memory storage, the processing unit being responsive to computer-executable instructions contained in the program code and operative to:
generate an installation script for managing installation operations;
if the installation operations are associated with the program file, combine the installation script with the program file associated with the installation operations;
generate the single executable file that includes the combined installation script and the program file;
distribute the single executable file; and
execute the single executable file, wherein executing the single executable file comprises querying a manifest within the single executable file, the manifest comprising a list of a plurality of cabinet (CAB) resource files external to the single executable file, wherein the plurality of (CAB) resource files are utilized by the single executable file to install the program file, wherein the program file comprises a software product.

17. The system of claim 16, wherein the processing unit, in querying a manifest within the single executable file, is further operative to query a markup language namespace section within the single executable file.

18. The system of claim 16, wherein the processing unit, in generating an installation script of managing installation operations, is further operative to generate an installation script based on a type of installation.

19. The system of claim 16, wherein the processing unit, in executing the single executable file, is further operative to:
detect a system parameter associated with a user computing device;
prompt a dialog to receive a user input for a script parameter;
receiving the user input;
perform predefined actions associated with the installation operations based on the detected system parameter and the received user input;
determine an error in response to an action not being performed properly;
prompt a dialog to provide the user a feedback;
report the error to a predefined monitoring application;
detect an existing software product component, if the installation is for an update;
determine whether the existing component is eligible for the update; and
perform post-installation actions that include at least one from a set of: registering the software product, deleting temporarily created files, and activating at least one component of the software product.

20. The system of claim 16, wherein the processing unit, in distributing the single executable file, is further operative to provide the file on a computer readable storage medium.
